(19) United States
(12) Patent Application Publication
(10) Pub. No.: US 2013/0152390 A1
(43) Pub. Date: Jun. 20, 2013

(54) PROCESS FOR PRODUCING A LIQUID EJECTION HEAD

(71) Applicant: Canon Kabushiki Kaisha, Tokyo (JP)

(72) Inventors: Akihiko Okano, Fujisawa-shi (JP); Takumi Suzuki, Yokohama-shi (JP); Motoki Okinaka, Inagi-shi (JP)

(73) Assignee: CANON KABUSHIKI KAISHA, Tokyo (JP)

(21) Appl. No.: 13/676,359

(22) Filed: Nov. 14, 2012

(30) Foreign Application Priority Data
Dec. 14, 2011 (JP) 2011-273281

(51) Int. Cl. B41J 2/16

(52) U.S. Cl. CPC B41J 2/1637
USPC 29/890.1

(57) ABSTRACT

Provided is a process for producing a liquid ejection head which includes a substrate having an energy generating element and a wall member joined with the substrate to form an ejection orifice which ejects liquid and a flow path which communicates to the ejection orifice, the process including, in the following order, the steps of (B) forming, on the substrate, a flow path pattern form for forming the flow path, (C) forming, around the flow path pattern form, a cover resin layer for forming the wall member, and (D) transferring a surface form of the substrate to a surface of the cover resin layer so as to correspond to a pattern of the surface form of the substrate.

### BACKGROUND OF THE INVENTION

1. Field of the Invention

The present invention relates to a process for producing a liquid ejection head.

2. Description of the Related Art

In general, an ink jet head, which is applied to an ink jet recording system (liquid ejection recording system) for performing recording by ejecting recording liquid, such as ink, has the following configuration. There are provided ink flow paths, energy generating elements disposed at parts of the ink flow paths, for ejecting ink droplets, and minute ink ejection orifices for ejecting ink in the ink flow paths by energy of the energy generating elements.

As a process for producing an ink jet head, for example, the following process is disclosed in Japanese Patent Application Laid-Open No. 2006-168345. A layer made of a photosensitive material is formed on a substrate on which energy generating elements are disposed, and a flow path pattern is exposed as a pattern on the layer. Next, a flat inorganic substrate is bonded onto the layer. After ejection orifices have been formed in the inorganic substrate, the flow path pattern is developed so as to form flow paths, thereby producing a liquid ejection head. This process is also called a casting process. Positive photoresist is used as the photosensitive material in the process from the viewpoint of easiness of removal. Moreover, according to this process, a method of photolithography used in the field of semiconductor is applied so that minute processing can be performed with a high degree of accuracy for forming the flow paths.

In recent years, higher image quality and higher speed of recording have been required. With this, it is required that the ejection orifices and the flow paths communicating to the ejection orifices be disposed with high density, and volumes of droplets to be ejected be kept uniform.

On the other hand, U.S. Pat. No. 6,716,767 discloses a process in which various materials for flattening are placed on a substrate on which various patterns have been formed, and are brought into contact with a flat object so as to flatten a surface.

### SUMMARY OF THE INVENTION

According to an exemplary embodiment of the present invention, there is provided a process for producing a liquid ejection head which includes a substrate having an energy generating element and a wall member joined with the substrate to form an ejection orifice which ejects liquid and a flow path which communicates to the ejection orifice, the process including, in the following order, the steps of: (B) forming, on the substrate, a flow path pattern form for forming the flow path; (C) forming, around the flow path pattern form, a cover resin layer for forming the wall member; and (D) transferring a surface form of the substrate to a surface of the cover resin layer so as to correspond to a pattern of the surface form of the substrate.

Further, according to an exemplary embodiment of the present invention, there is provided a process for producing a structure including a resin shaped article on a substrate, the process including, in the following order, the steps of: forming, on the substrate, a resin layer for forming the resin shaped article; and transferring a surface form of the substrate to a surface of the resin layer so as to correspond to a pattern of the surface form of the substrate.

Further features of the present invention will become apparent from the following description of exemplary embodiments with reference to the attached drawings.

### BRIEF DESCRIPTION OF THE DRAWINGS

FIG. 1 is a schematic perspective view illustrating an example of a liquid ejection head which is produced by a process according to the present invention.

FIG. 2 is a schematic cross-sectional view of a liquid ejection head which is produced by processes described in Japanese Patent Application Laid-Open No. 2006-168345 and U.S. Pat. No. 6,716,767.

FIGS. 3A, 3B, 3C, 3D, 3E, 3F, 3G and 3H are schematic cross-sectional views illustrating an example of a process for producing a liquid ejection head according to the present invention.

FIG. 4 is a schematic cross-sectional view illustrating an example of a liquid ejection head which is produced by the process according to the present invention.

FIGS. 5A, 5B, 5C, 5D, 5E, 5F, 5G, 5H, 5I and 5J are schematic cross-sectional views illustrating another example of the process for producing a liquid ejection head according to the present invention.

### DESCRIPTION OF THE EMBODIMENTS

In order to enable an ink jet head to achieve higher image quality, it is required to keep uniform volumes of ink droplets to be ejected. The volume of ink droplets to be ejected is significantly affected by a distance between an energy generating element and an ejection orifice. Thus, as the dispersion of the distances between the energy generating elements and the corresponding ejection orifices on a substrate is smaller, the volumes of the ink droplets ejected from the respective ejection orifices are more uniform.

In the process described in Japanese Patent Application Laid-Open No. 2006-168345, when the process of U.S. Pat. No. 6,716,767 is applied to an inorganic substrate 1 so as to further flatten the surface of the inorganic substrate, the surface of the inorganic substrate becomes flattened with a high degree of accuracy as illustrated in FIG. 2. However, a substrate 2 made of silicon generally varies in thickness so that unevenness of a variety of shapes in size and height is generated on the surface of the substrate 2. Due to this unevenness, even if the surface of the inorganic substrate 1 is flat, energy generating elements 3, which are disposed on the substrate 2, vary in height on the surface of the substrate 2. Accordingly, distances H1 between the energy generating elements 3 and corresponding ejection orifices 4 vary individually in the plane of the substrate 2. Thus, the volumes of ink droplets ejected from the respective ejection orifices become non-uniform, and further the printing quality is degraded.

Moreover, in FIG. 2, distances H2 between the energy generating elements 3 and a flow path ceiling portion also vary. In particular, with regard to a system in which all liquid present above the energy generating element 3 (on the ejection orifice 4 side) is ejected, the distance H2 significantly affects the volume of ink droplets. Accordingly, the dispersion of the volumes of ink droplets tends to become larger when the distance H2 varies.

The present invention has been made in view of the above-mentioned problem, and has an object to produce a liquid ejection head which is capable of ejecting liquid droplets with uniform liquid volumes.

Process for Producing Liquid Ejection Head

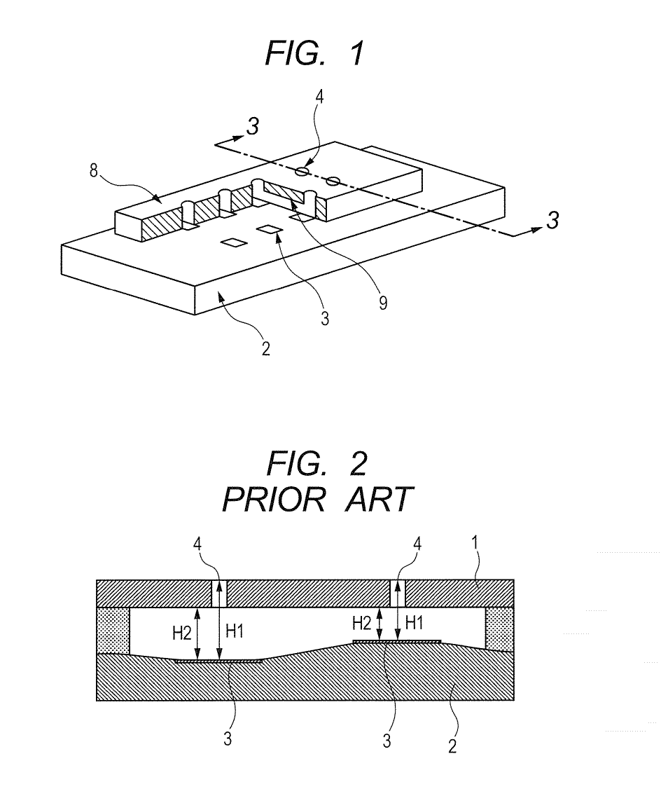

A process for producing a liquid ejection head according to the present invention is described below with reference to FIGS. 1, 3A to 3H, and 4.

An example of a liquid ejection head, which is produced by the process according to the present invention, is illustrated in FIG. 1. The liquid ejection head illustrated in FIG. 1 includes a substrate 2 on which energy generating elements 3 for generating energy to be used for ejecting liquid, such as ink, are formed with a given pitch. A supply port (not shown) for supplying liquid is disposed on the substrate 2. On the substrate 2, a wall member 8 is joined with the substrate 2 so as to form the ejection orifices 4 which are opened above the energy generating elements 3, and a flow path 9 for liquid which communicate the respective ejection orifices 4 to the supply port.

### First Embodiment

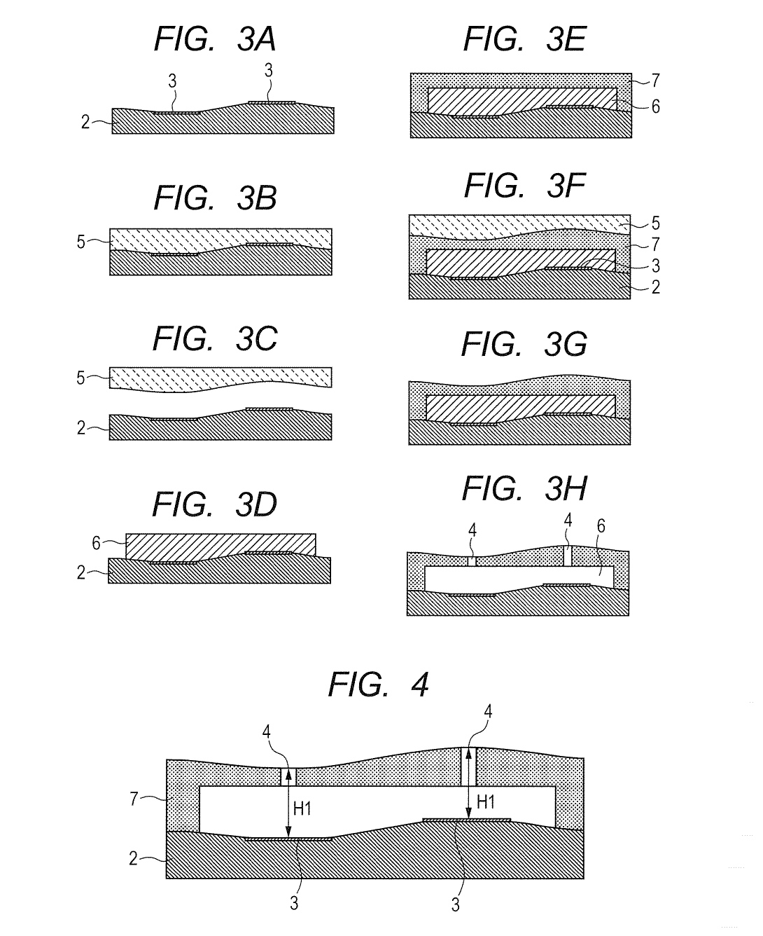

A process for producing a liquid ejection head according to a first embodiment of the present invention is described with reference to FIGS. 3A to 3H. FIGS. 3A to 3H are cross-sectional views illustrating cross sections of the liquid ejection head along the plane 3-3 of FIG. 1 in the respective steps.

As illustrated in FIG. 3A, multiple energy generating elements 3 and wirings or the like (not shown) are disposed on the substrate 2. The largest variation of thicknesses of the substrate 2 made of silicon, which is used in a general semiconductor manufacturing process, is 1 μm or more. The energy generating elements 3 are disposed on the substrate 2 having this variation in thicknesses, and hence the heights of the respective energy generating elements 3 have a dispersion of 1 μm or more.

Step (A)

As illustrated in FIG. 3B, a replica mold 5 is pressed against a surface of the substrate 2. As a material of the replica mold 5, a photocurable resin, a thermosetting resin, and a silicone compound, such as polydimethylsiloxane (PDMS), which are commonly used in the nanoimprint industry, can be used. As the photocurable resin, a fluorine-based polyvinyl fluoride resin and the like can be used. As commercial products, CYTOP (product name; produced by Asahi Glass Co., Ltd.), NIF (product name; produced by Asahi Glass Co., Ltd.), and the like can be used. As the thermosetting resin, a polysilane-based resin, a cycloolefin-based resin, a fluororesin, and the like, can be used. One kind of those resins may be used, or two or more kinds of those resins may be used in combination. Among others, the fluorine-based resin is preferred because there can be also obtained such an advantageous effect that the mold releasability of the replica mold 5 can be improved. Moreover, when a cover resin layer 7, which is described later, is hard, it is also preferred to use a material having a high degree of rigidity which is produced by forming a conductive layer as an electric current seed layer on the surface of the substrate 2, and dipping the conductive layer into an electroforming bath so that a film grows by plating growth.

Moreover, in a step of pressing the replica mold 5 against a surface of the cover resin layer 7, which is described later, the replica mold 5 may be pressed while being heated. In this case, as a material of the replica mold 5, it is preferred to use a material having a glass transition point which is higher than the glass transition point of the material of the cover resin layer 7. The glass transition point is a value which is measured by differential scanning calorimetry (DSC). Note that, in the step of pressing the replica mold 5 against the surface of the cover resin layer 7, which is described later, the material of the replica mold 5 is not limited to this, as long as the material prevents the shape of the replica mold 5 from being deformed when the replica mold 5 is pressed.

The applied pressure for pressing the replica mold 5 against the surface of the substrate 2 may be set to, for example, preferably 0.1 MPa or more and 10 MPa or less, more preferably 1 MPa or more and 3 MPa or less, although it depends on the material of the replica mold 5. The temperature when the replica mold 5 is pressed against the surface of the substrate 2 may be set to, for example, preferably 25° C. or more and 170° C. or less, more preferably 25° C. or more and 80° C. or less, and also to room temperature, although it depends on the material of the replica mold 5. Moreover, in order to prevent air from entering the space between the substrate 2 and the replica mold 5, it is preferred to press the replica mold 5 against the surface of the substrate 2 in an atmosphere of a reduced pressure. Moreover, when needed, the substrate 2 and the replica mold 5 may be subjected to heat treatment before being pressed. The heating condition may be, for example, 50° C. or more and 100° C. or less.

As illustrated in FIG. 3C, when the replica mold 5 is released from the substrate 2, there can be obtained the replica mold 5 on which the surface form of the substrate 2 has been transferred. At this time, in order to easily perform the releasing, it is preferred that the surface of the substrate 2 be provided with a release layer in advance. Moreover, in order to increase the strength of the replica mold 5, it is preferred that the released replica mold 5 be subjected to heat and light to such an extent that no deformation occurs in the released replica mold 5. Note that, in this embodiment, the replica mold 5 is pressed against the substrate 2 so that the surface form of the substrate 2 is transferred to the replica mold 5. However, the process of transferring the surface form of the substrate 2 to the replica mold 5 in the present invention is not limited to this process, and a publicly known transfer process may be appropriately used.

Step (B)

As illustrated in FIG. 3D, a flow path pattern form 6 for forming the flow path 9 is formed on the surface of the substrate 2. The flow path pattern form 6 is removed in the subsequent step so that a photosensitive resin, a thermosensitive resin, or the like may be used as the material of the flow path pattern form 6. A positive photosensitive resin is preferred to be used as the photosensitive resin. Note that, the material for the flow path pattern form 6 is not limited to those materials. When the positive photosensitive resin is used for the material of the flow path pattern form 6, for example, a solution including the photosensitive resin is applied to the substrate 2, and prebaking is performed so as to form a photosensitive resin layer. The process of applying the solution is not particularly limited, and, for example, a spin-coating process and the like may be used for the application. Exposure is performed for the photosensitive resin layer through a mask on which a pattern of the flow paths 9 is drawn, and development is performed so as to form the flow path pattern form 6. The amount of the exposure and the kind of the developing solution can be appropriately selected in accordance with the material of the flow path pattern form 6.

Step (C)

As illustrated in FIG. 3E, the cover resin layer 7 for forming the wall member 8 is formed around the flow path pattern form 6. In order to form the ejection orifices 4 in the cover resin layer 7 in a step (E) which is described later, it is preferred to use a negative photosensitive resin as the material of the cover resin layer 7. Moreover, as described above, in the step (D) of pressing the replica mold 5 against the surface of the cover resin layer 7, which is described later, the replica mold 5 may be pressed while being heated. In this case, as the material of the cover resin layer 7, it is preferred to use a material having a glass transition point which is lower than the glass transition point of the material of the replica mold 5 so that the cover resin layer 7 can flow when the replica mold 5 is pressed against the cover resin layer 7. When the negative photosensitive resin is used for the material of the cover resin layer 7, for example, a solution including the photosensitive resin is applied so as to cover the circumference of the flow path pattern form 6, and prebaking is performed so as to form the cover resin layer 7. The process of applying the solution is not particularly limited, and, for example, a spin-coating process and the like may be used for the application. Moreover, the surface of the cover resin layer 7 may be provided with a processing layer for providing water repellency and the like thereto.

Step (D)

As illustrated in FIG. 3F, the replica mold 5 is pressed against the surface of the cover resin layer 7 so that the pattern transferred to the replica mold 5 and the pattern of the surface form of the substrate 2 correspond to each other. With this, the surface form of the substrate 2 is transferred to the surface of the cover resin layer 7.

The surface of the cover resin layer 7 is provided with unevenness of a variety of shapes in size and height due to the unevenness of the substrate 2 and the difference in level of the flow path pattern form 6. When the ejection orifices 4 are formed in the subsequent step, this unevenness causes the dispersion of heights between the surface of the cover resin layer 7 and the energy generating elements 3. When the dispersion of heights occurs, dispersion of volumes of droplets, which are ejected from the ejection orifices 4, is caused, and hence defective printing may be caused when performing printing. As a process of resolving the problem of the dispersion of heights, there can be used a process of flattening the surface of the cover resin layer 7. For example, as a physical process, there can be used a process of pressing a flat plate against the cover resin layer 7 as described in U.S. Pat. No. 6,716,767, a process of pressing a roller against the cover resin layer 7, and the like. Moreover, as a chemical process, there can be used a process of heating the cover resin layer 7 so as to flow, a process of adjusting the amount of solvent included in the cover resin layer 7 so as to perform leveling, and the like. Further, there can be used a process of bonding an inorganic substrate as described in Japanese Patent Application Laid-Open No. 2006-168345.

The process of bonding an inorganic substrate as described in Japanese Patent Application Laid-Open No. 2006-168345 is effective as a process of controlling the surface with a high degree of accuracy. However, the range of the thickness dispersion of the substrate 2 is 1 μm or more. Therefore, even if the surface of the inorganic substrate 1 is flat, the energy generating elements 3, which are disposed on the substrate 2, are affected by the thickness dispersion of the substrate 2 to generate dispersion of 1 μm or more in the distances between the energy generating elements 3 and the ejection orifices 4. Accordingly, within the same substrate 2, the distances between the energy generating elements 3 and the ejection orifices 4, which are important for determining the volumes of droplets to be ejected, cause dispersion to thereby generate dispersion in the ejection amounts of droplets which are ejected from the respective ejection orifices 4.

Moreover, the process of pressing a flat plate against the cover resin layer 7 as described in U.S. Pat. No. 6,716,767 is effective as a process which can easily flatten the surface. In a general pressing process in which pressing is performed while being interposed between a stage and a flat plate, the surface of the cover resin layer 7 becomes a relatively flat condition in accordance with the unevenness of the flat plate. However, the substrate 2 is pressed against the stage to be deformed, and the rear surface of the substrate 2 has the flatness of the stage. Therefore, the dispersion of thicknesses of the substrate 2 reflects the thickness of the cover resin layer 7, thereby generating a dispersion of several micrometers in the thickness of the cover resin layer 7.

The volume of droplets is dominantly determined by the volume which is obtained by multiplying the distance between the energy generating element 3 and the plane of the ejection orifice 4 by the area of the ejection orifice 4. Therefore, the dispersion of thicknesses of the cover resin layer 7 above the energy generating elements 3 causes the dispersion of the volumes of the droplets. Accordingly, it is insufficient for keeping uniform volumes of droplets, which are ejected from the respective ejection orifices 4, to only flatten the surface of the cover resin layer 7.

Therefore, after the extensive study, the inventors of the present have found that the heights between the surface of the substrate 2 and the surface of the cover resin layer 7 can be kept uniform at any part of the substrate 2 by transferring the surface form of the substrate 2 to the surface of the cover resin layer 7 so as to correspond to the pattern of the surface form of the substrate 2. A preferred process of transferring the surface form of the substrate 2 to the surface of the cover resin layer 7 is to press the replica mold 5, to which the surface form of the substrate 2 has been transferred so as to correspond to the pattern of the surface form of the substrate 2, against the surface of the cover resin layer 7. According to this process, the difference of heights H1 illustrated in FIG. 4 between the energy generating elements 3, which are disposed on the surface of the substrate 2, and the corresponding ejection orifices 4, which are formed in the cover resin layer 7, can be kept equal to or less than 1 μm. Therefore, all of the volumes of droplets, which are ejected from the ejection orifices 4, can be kept uniform with a high degree of accuracy.

A preferred process of pressing the replica mold 5 is to align the position of the substrate 2 and the position of the replica mold 5 so that the pattern transferred to the replica mold 5 and the pattern of the surface form of the substrate 2 correspond to each other to press the replica mold 5. Moreover, because the cover resin layer 7 flows so as to follow the form of the replica mold 5 which is pressed against the cover resin layer 7, it is preferred to continuously press the replica mold 5 so that the replica mold 5 becomes parallel to the surface of the substrate 2 after being pressed. In order to absorb the thickness dispersion of the substrate 2 and the difference in level occurring in the IC process, a press machine is adjusted so as to perform pressing orthogonally with respect to the substrate 2 while using the rear surface of the substrate 2 as a reference, and the substrate 2 and the replica mold 5 are inserted to the press machine to achieve uniformity, namely, the front surface is not used as the reference. Therefore, for example, in order to continuously maintain the state in which the substrate 2 and the replica mold 5 are parallel to each other while the replica mold 5 is being pressed, the press machine can perform pressing while the positions of the surface of the substrate 2 and the surface of the replica mold 5 are controlled.

It is preferred that the replica mold 5 be pressed in an atmosphere of a reduced pressure in order to prevent air from entering the space between the substrate 2 and the replica mold 5, prevent displacement due to solvent vapor, which is generated from the cover resin layer 7, and prevent the resin of the cover resin layer 7 from being swept away. Specifically, it is preferred that the replica mold 5 be pressed against the surface of the cover resin layer 7 under a pressure of 100 Pa or less. Moreover, in order to improve the resin fluidity of the cover resin layer 7 when the replica mold 5 is pressed, it is preferred that the replica mold 5 be pressed under a temperature which is equal to or higher than the glass transition point of the material of the cover resin layer 7. The temperature, under which the replica mold 5 is pressed against the surface of the cover resin layer 7, may be, for example, 80° C. or more and 150° C. or less. However, even when the temperature is equal to or lower than the glass transition point, it is possible to apply a pressure for a given period of time so that transfer to the cover resin layer 7 can be performed.

Moreover, in order to reproduce the amount of deformation of the substrate 2 which has been generated when the substrate 2 is pressurized at the time of producing the replica mold 5, it is preferred that the applied pressure for pressing the replica mold 5 against the cover resin layer 7 be set equal to the applied pressure at the time of producing the replica mold 5, and the amount of deformation be transferred to the surface of the cover resin layer 7. Note that, when the applied pressure for pressing the replica mold 5 against the cover resin layer 7 falls within the range of 0.9 times or more and 1.1 times or less as much as the applied pressure at the time of producing the replica mold 5, the applied pressures are considered to be equal. However, the applied pressures are not necessarily equal as long as the amount of deformation of the substrate 2 can be reproduced.

As illustrated in FIG. 3G, the replica mold 5 is released from the cover resin layer 7, and thus the surface form of the substrate 2 is transferred to the surface of the cover resin layer 7. At this time, in order to easily perform mold releasing, it is preferred that a step of forming a release layer on the surface of the cover resin layer 7 be performed after the formation of the cover resin layer 7 and prior to the transfer of the surface form of the substrate 2. Moreover, a material having crosslinkable photosensitivity which is equivalent to that of the negative photosensitive resin is preferred. As a material for the release layer, there can be used fluorine-based compounds and the like. A single kind of those compounds may be used, or two or more kinds of those compounds may be used in combination. Note that, the process according to the present invention is not limited to the process which uses the replica mold 5, and other processes may be applied as long as the process enables transfer of the surface form of the substrate 2 to the cover resin layer surface so as to correspond to the pattern of the surface form of the substrate 2.

Step (E)

After that, the ejection orifices 4 are formed in the cover resin layer 7. The process of forming the ejection orifices 4 is not particularly limited. However, when a photosensitive resin is used for the material of the cover resin layer 7, for example, the cover resin layer 7 may be exposed through a mask on which a pattern of the ejection orifices 4 is drawn, subjected to PEB, and then developed so as to form the ejection orifices 4. The amount of exposure and the kind of developing solution can be appropriately selected in accordance with the material of the cover resin layer 7.

A liquid supply port (not shown) is formed on the rear surface of the substrate 2. The process of forming the liquid supply port is not particularly limited. For example, after forming a protective layer on the front surface of the substrate 2, an etching mask may be formed on the rear surface of the substrate 2, and anisotropic etching is performed so as to form the liquid supply port. The material of the protective layer is not particularly limited as long as the material is resistant to an etchant which is used for the anisotropic etching. As the etchant which is used for the anisotropic etching, for example, a tetramethylammonium hydroxide water solution and the like can be used. After that, the protective layer is removed.

As illustrated in FIG. 3H, by removing the flow path pattern form 6, the liquid ejection head can be produced. When a positive photosensitive resin is used as the material of the flow path pattern form 6, an entire surface of the substrate 2 is exposed, and development is performed so that the flow path pattern form 6 can be removed. The amount of exposure and the kind of developing solution can be appropriately selected in accordance with the material of the flow path pattern form 6.

### Second Embodiment

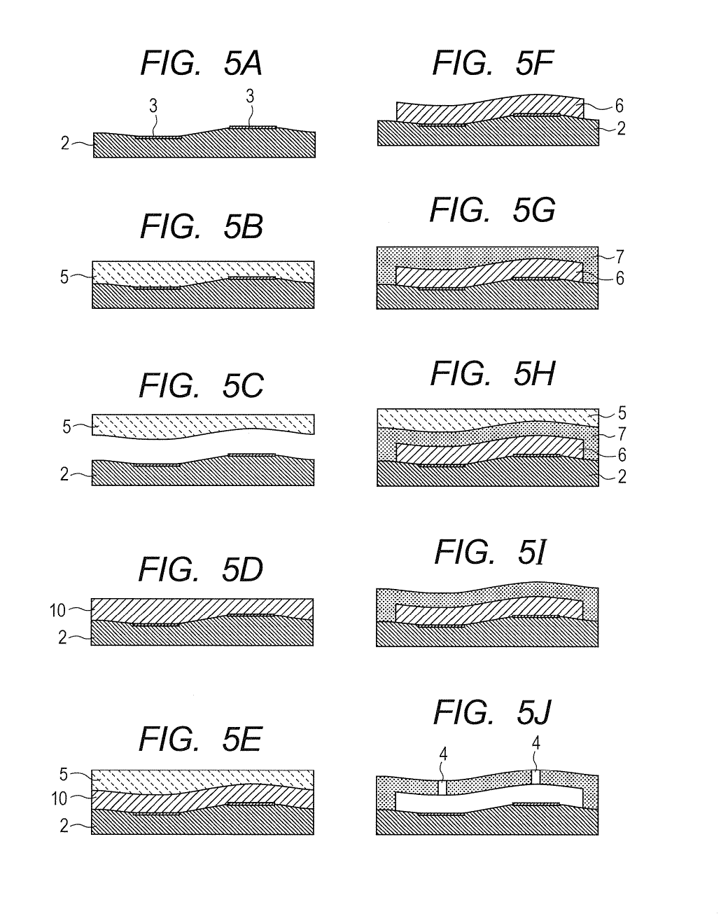

A process for producing a liquid ejection head according to a second embodiment of the present invention is described with reference to FIGS. 5A to 5J. FIGS. 5A to 5J are cross-sectional views illustrating cross sections of the liquid ejection head along the plane 3-3 of FIG. 1 in the respective steps.

Step (A)

With regard to FIGS. 5A to 5C, the step can be similar to the step (A) of the first embodiment.

Step (B)

As illustrated in FIG. 5D, a flow path pattern layer 10 is formed on the substrate 2. The formation of the flow path pattern layer 10 can be performed in a way similar to that of the first embodiment. Note that, when a positive photosensitive resin is used as the material of the flow path pattern layer 10, the flow path pattern layer corresponds to the photosensitive resin layer of the first embodiment.

As illustrated in FIG. 5E, the replica mold 5 is pressed against the flow path pattern layer surface so that the pattern transferred to the replica mold 5 and the pattern of the surface form of the substrate 2 correspond to each other, thereby transferring the surface form of the substrate 2.

When a positive photosensitive resin is used as the material of the flow path pattern layer 10, because the solvent evaporates after the prebaking so that the viscosity is increased, it is preferred that the applied pressure for pressing the replica mold 5 against the flow path pattern layer 10 be high. On the other hand, because there is a risk that deformation of the replica mold 5 and the like may be caused, it is preferred that the applied pressure for pressing the replica mold 5 against the flow path pattern layer 10 be equal to the applied pressure for pressing the replica mold against the cover resin layer 7 in the step (D). Note that, when the level of the applied pressure for pressing the replica mold 5 against the flow path pattern layer 10 falls within the range of 0.9 times or more and 1.1 times or less as much as the applied pressure for pressing the replica mold against the cover resin layer 7, the applied pressures are considered to be equal. Moreover, in this case, because the glass transition point of the positive photosensitive resin is high, it is sometimes difficult to heat the positive photosensitive resin to a temperature which is equal to or higher than the glass transition point. Accordingly, it is preferred to use the replica mold 5 having rigidity which is high enough to prevent deformation when the replica mold 5 is pressed under high pressure. The other transferring processes can be the same as the step (D) of the first embodiment.

As illustrated in FIG. 5F, the flow path pattern layer 10 is formed into the flow path pattern form 6 by forming the pattern of the flow path 9 thereon. The process of forming the pattern of the flow path 9 can be similar to that of the first embodiment.

Steps (C) to (E)

With regard to FIGS. 5G to 5J, the steps can be similar to the steps (C) to (E) of the first embodiment. After that, the liquid supply port (not shown) is formed, and the flow path pattern form 6 is removed. With this, the liquid ejection head can be produced.

According to the process of the second embodiment, the distances H2 between the respective energy generating elements 3 on the substrate 2 and the flow path ceiling portion and the distances between the flow path ceiling portion and the ejection orifices 4 can be kept uniform so that the flow of liquid can be kept uniform. With this, the amounts of liquid, which is supplied to the ejection orifices 4, are kept uniform so that the liquid can be ejected while no fluctuation occurs when the liquid is refilled.

According to the liquid ejection head which is produced by the process according to the present invention, the dispersion of the liquid amounts of the ejected droplets is decreased so that the droplets having uniform amounts of liquid can be repeatedly ejected under a stable condition. Particularly, in the system in which the liquid present above the energy generating element 3 (on the ejection orifice 4 side) is entirely ejected, a significant effect can be obtained for suppressing the dispersion of volumes of the droplets. Note that, in such an ejection system, for example, when a thermal heater is used as the energy generating element 3, bubbles, which are generated at the thermal heater, communicate to the atmosphere.

Moreover, because the dispersion of the liquid amounts of the ejected droplets is suppressed, the flow of liquid, which is refilled after ejection, and the bubble form can be stabled so that the printing quality can be improved. Moreover, the flow path 9, which communicates to the ejection orifices 4, is formed with a high degree of accuracy so as to improve the reliability. In addition, the process according to the present invention enables the liquid ejection head to be produced with a high yield rate.

The liquid ejection head, which is produced by the process according to the present invention, can be mounted on apparatus, such as a printer, a copying machine, a facsimile machine having a communication system, and a word processor having a printing portion, and further on an industrial recording apparatus which is complexly combined with various processing apparatus. Moreover, the liquid ejection head can also be used for producing a biochip, printing an electronic circuit, and ejecting medicines to be sprayed.

Process for Producing Structure

A process for producing a structure according to the present invention is a process for producing a structure including a resin shaped article on a substrate. This process includes, in the following order, a step of forming a resin layer for forming the resin shaped article on the substrate and a step of transferring the surface form of the substrate to the resin layer surface so as to correspond to the pattern of the surface form of the substrate.

Similarly to the process for producing a liquid ejection head according to the present invention, it is preferred that the process for producing a structure according to the present invention include, prior to the step of forming the resin layer, a step of producing a replica mold to which the surface form of the substrate has been transferred by being pressed against the substrate surface. Moreover, it is preferred that the step of transferring the surface form of the substrate to the resin layer surface be a step of pressing the replica mold against the resin layer surface so that the pattern transferred to the replica mold and the pattern of the surface form of the substrate correspond to each other.

### EXAMPLES

In the following, examples of the present invention are described, but the present invention is not limited to the following examples.

### Example 1

In this example, an ink jet head was produced by the process which is illustrated in FIGS. 3A to 3H.

First, there was prepared the substrate 2 made of silicon on which the energy generating elements 3 for ejecting ink, and a driver and a logic circuit (not shown), were formed (FIG. 3A).

A mold material made of a fluororesin (product name F-template; produced by Asahi Glass Co., Ltd.) was pressed against the surface of the substrate 2 by using a press machine (product name ST-50; produced by Toshiba Machine Co., Ltd.) in a vacuum chamber while being heated from above and below and being pressurized (FIG. 3B). After that, the mold material was cooled, and the substrate 2 was released therefrom, thereby producing the replica mold 5 (FIG. 3C).

Next, the flow path pattern form 6 made of a photodegradable positive resist was formed on the substrate 2 by the following process. As the photodegradable positive resist, a polymethyl isopropenyl ketone (product name ODUR-1010; produced by Tokyo Ohka Kogyo Co., Ltd.) was used. There was prepared a coating liquid including the photodegradable positive resist with a concentration of 20 mass %. The coating liquid was applied to the substrate 2 by a spin-coating process. After that, prebaking was performed on a hot plate at 120° C. for 3 minutes, and subsequently in an oven, to which nitrogen purge was performed, at 150° C. for 30 minutes, so as to form a positive resist layer having a film thickness of 5 μm. Deep-UV light with an amount of exposure of 18,000 mJ/cm² was applied on the positive resist layer through a mask, on which a flow path pattern was drawn, by using a Deep-UV exposure apparatus (product name UX-3000; produced by USHIO INC.). Development was performed by using a solution of methyl isobutyl ketone (MIBK)/xylene=2/3 (volume ratio), which was a nonpolar solvent. Moreover, rinsing treatment was performed by using xylene so as to form the flow path pattern form 6 on the substrate 2 (FIG. 3D).

Next, the cover resin layer 7, which was made of a negative photocurable resin, was formed around the flow path pattern form 6 by the following process. As the photocurable resin, the resist solution having the following composition was used.
EHPE-3150 (product name; produced by Daicel Corporation): 100 parts by mass
HFAB (product name; produced by Central Glass Co., Ltd.): 20 parts by mass
A-187 (product name; produced by Nippon Unicar Co., Ltd.): 5 parts by mass
SP170 (product name; produced by ADEKA Corporation): 2 parts by mass
Xylene: 80 parts by mass

The resist solution was applied by a spin-coating process so as to cover the circumference of the flow path pattern form 6. Prebaking was performed on a hot plate at 90° C. for 3 minutes so that the plate-shaped cover resin layer 7 having a film thickness of 10 μm was formed (FIG. 3E).

Next, the position of the substrate 2 and the position of the replica mold 5 were aligned with each other so that the pattern transferred to the replica mold 5 and the pattern of the surface form of the substrate 2 corresponded to each other. The replica mold 5 was pressed against the surface of the cover resin layer 7 by using a press machine (product name ST-50; produced by Toshiba Machine Co., Ltd.) in a vacuum chamber while being heated from above and below and being pressurized (FIG. 3F). After being pressed, the replica mold 5 was released therefrom (FIG. 3G).

Further, pattern exposure was performed for the cover resin layer 7 through a mask, on which an ejection orifice pattern was drawn, by using a mask aligner (product name MPA600FA; produced by Canon Inc.) with an amount of exposure of 3,000 mJ/cm². PEB was performed at 90° C. for 180 seconds so as to cure an un-exposed portion. Development was performed by using a solution of methyl isobutyl ketone/xylene=2/3 (volume ratio). Rinsing treatment was performed by using xylene so as to form the ejection orifices 4.

Next, an ink supply port (not shown) was formed on the rear surface of the substrate 2 by etching processing according to the following process. A protective layer was applied to the front surface of the substrate 2. A slit-shaped etching mask was formed on the rear surface of the substrate 2 with a positive resist. The substrate 2 was dipped into a tetramethylammonium hydroxide water solution at 80° C. so as to perform anisotropic etching for the substrate 2, thereby forming the ink supply port.

Next, the protective layer was removed. After that, an entire surface of the substrate 2 was exposed with an amount of exposure of 7,000 mJ/cm² by using a Deep-UV exposure apparatus (product name UX-3000; produced by USHIO INC.) so that the flow path pattern form 6 was solubilized. Then, the substrate 2 was dipped into methyl lactate while an ultrasonic wave was applied so as to remove the flow path pattern form 6, thereby producing an ink jet head (FIG. 3H).

As illustrated in FIG. 4, in the ink jet head which was produced by the process of this example, all of the differences of the distances H1 between the energy generating elements 3 on the substrate 2 and the corresponding ejection orifices 4 fell within ±1 μm so as to have a uniform shape. The ink jet head was mounted on a printer, and evaluation of ink ejection and recording was performed so as to reveal that ink droplets were ejected with uniform volumes from the respective ejection orifices 4, and a printed product with high quality was obtained.

### Example 2

An ink jet head was produced in a way similar to that of Example 1, except that the step of forming the flow path pattern form 6 was performed by the following step.

Similarly to Example 1, a positive resist layer as the flow path pattern layer 10 was formed on the substrate 2. The position of the substrate 2 and the position of the replica mold 5 were aligned with each other so that the pattern transferred to the replica mold 5 and the pattern of the surface form of the substrate 2 corresponded to each other. The replica mold 5 was pressed against the surface of the positive resist layer by using a press machine (product name ST-50; produced by Toshiba Machine Co., Ltd.) in a vacuum chamber while being heated from above and below and being pressurized. After being pressed, the replica mold 5 was released therefrom. After that, similarly to Example 1, exposure, development, and rinsing treatment were performed for the positive resist layer, thereby forming the flow path pattern form 6 on the substrate 2.

In the ink jet head which was produced by the process of this example, all of the differences of the distances H2 between the respective energy generating elements 3 on the substrate 2 and the flow path ceiling portion, and the distances between the flow path ceiling portion and the ejection orifices 4 fell within ±1 μm so as to have a uniform shape. The ink jet head was mounted on a printer, and evaluation of ink ejection and recording was performed so as to reveal that ink droplets were ejected with uniform volumes from the respective ejection orifices 4, and a printed product with high quality was obtained.

### Comparative Example 1

After forming the cover resin layer 7, instead of pressing the replica mold 5 against the surface of the cover resin layer 7, a silicon plate having a flat surface was pressed. The other steps were similar to those of Example 1, and an ink jet head was produced.

In the ink jet head which was produced by the process of this comparative example, the differences of the distances H1 between the energy generating elements 3 on the substrate 2 and the corresponding ejection orifices 4 had a dispersion of several micrometers. The ink jet head was mounted on a printer, and evaluation of ink ejection and recording was performed so as to reveal that the volumes of ink droplets, which were ejected from the respective ejection orifices 4, were dispersed, and a blur of characters was observed on the printed material.

According to the present invention, there can be produced a liquid ejection head which can eject droplets having uniform amounts of liquid.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2011-273281, filed Dec. 14, 2011, which is hereby incorporated by reference herein in its entirety.

What is claimed is:

1. A process for producing a liquid ejection head which includes a substrate having an energy generating element and a wall member joined with the substrate to form an ejection orifice which ejects liquid and a flow path which communicates to the ejection orifice, the process comprising, in the following order, the steps of:
(B) forming, on the substrate, a flow path pattern form for forming the flow path;
(C) forming, around the flow path pattern form, a cover resin layer for forming the wall member; and
(D) transferring a surface form of the substrate to a surface of the cover resin layer so as to correspond to a pattern of the surface form of the substrate.

2. A process for producing a liquid ejection head according to claim 1, further comprising, prior to the step (B), a step (A) of producing a replica mold to which the surface form of the substrate has been transferred by being pressed against a surface of the substrate,
wherein the step (D) comprises a step of pressing the replica mold against the surface of the cover resin layer so that a pattern transferred to the replica mold and the pattern of the surface form of the substrate correspond to each other.

3. A process for producing a liquid ejection head according to claim 2, wherein the step (B) comprises in the following order, the steps of forming a flow path pattern layer on the substrate, pressing the replica mold against a surface of the flow path pattern layer so that a pattern transferred to the replica mold and the pattern of the surface form of the substrate correspond to each other to thereby transfer the surface form of the substrate, and forming the flow path pattern form by forming a pattern of the flow path on the flow path pattern layer.

4. A process for producing a liquid ejection head according to claim 3, wherein the step of pressing the replica mold in at least one of the step (B) and the step (D) comprises a step of aligning a position of the substrate and a position of the replica mold with each other so that the pattern transferred to the replica mold and the pattern of the surface form of the substrate correspond to each other to press the replica mold against one of the surface of the flow path pattern layer and the surface of the cover resin layer.

5. A process for producing a liquid ejection head according to claim 2, wherein an applied pressure for pressing the replica mold against the surface of the cover resin layer in the step (D) is equal to an applied pressure for pressing the replica mold against the surface of the substrate in the step (A).

6. A process for producing a liquid ejection head according to claim 2, wherein a glass transition point of a material of the replica mold is higher than a glass transition point of a material of the cover resin layer.

7. A process for producing a liquid ejection head according to claim 2, wherein a material of the replica mold is one of a photocurable resin and a thermosetting resin.

8. A process for producing a liquid ejection head according to claim 2, wherein a material of the replica mold is a fluororesin.

9. A process for producing a liquid ejection head according to claim 1, further comprising, after the step (D), a step (E) of forming the ejection orifice in the cover resin layer.

10. A process for producing a liquid ejection head according to claim 1, further comprising, between the step (C) and the step (D), a step of forming a release layer on the surface of the cover resin layer.

11. A process for producing a structure including a resin shaped article on a substrate, the process comprising, in the following order, the steps of:
forming, on the substrate, a resin layer for forming the resin shaped article; and
transferring a surface form of the substrate to a surface of the resin layer so as to correspond to a pattern of the surface form of the substrate.

12. A process for producing a structure according to claim 11, further comprising, prior to the step of forming the resin layer, a step of producing a replica mold to which the surface form of the substrate has been transferred by being pressed against a surface of the substrate,
wherein the step of transferring the surface form of the substrate to the surface of the resin layer comprises a step of pressing the replica mold against the surface of the resin layer so that a pattern transferred to the replica mold and the pattern of the surface form of the substrate correspond to each other.
